(19) United States
(12) Patent Application Publication
(10) Pub. No.: US 2004/0214146 A1
(43) Pub. Date: Oct. 28, 2004

(54) Learning device including motion activated switch

(75) Inventors: Jason Harris, San Francsico, CA (US); Thomas Chan, Hong Kong (CN)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA

(21) Appl. No.: 10/745,399

(22) Filed: Dec. 22, 2003

Related U.S. Application Data
(60) Provisional application No. 60/436,670, filed on Dec. 27, 2002.

(51) Int. Cl. G09B 19/02

(52) U.S. Cl. 434/191

(57) ABSTRACT

A hand-held learning device is disclosed. The hand-held learning device includes a housing and a processor unit in the housing. A memory unit is coupled to the processor unit, and the memory unit comprises code for at least one problem. A motion activated switch is coupled to the processor unit. The motion activated switch is activated after a user of the hand-held learning device moves the entire hand-held interactive learning device from a first position to a second position. An output device is coupled to the processor unit and presents the problem or the answer to the problem to the user.

### CROSS-REFERENCES TO RELATED APPLICATIONS

This application is a non-provisional of and claims the benefit of the filing date of U.S. Provisional Patent Application No. 60/436,670, filed on Dec. 27, 2002. This U.S. Provisional Patent Application is herein incorporated by reference in its entirety for all purposes.

### BACKGROUND OF THE INVENTION

Devices for teaching mathematics are known. One such device is called the Math Shark™. According to product descriptions, it has an LCD (liquid crystal display) screen that displays problems and gives feedback to the user after the user has attempted the problems. Also, according to the product descriptions, it sharpens mental math skills from basics to pre-algebra with eight levels of skill. Buttons are provided on the product so that the user can input numbers and answers.

While devices such as the Math Shark™ are effective in some instances, a number of improvements could be made. For example, when using the Math Shark™, a user must input numbers using buttons. In a sense, the product is similar to an ordinary calculator. It does not engage the user in a way that is any better than an ordinary calculator.

What is needed is a device that engages the user in more creative ways to keep learning fun so that the user can learn difficult subjects such as math. Embodiments of the invention address these and other problems

### BRIEF SUMMARY OF THE INVENTION

Embodiments of the invention include hand-held learning devices and methods for using the same.

One embodiment of the invention is directed to a hand-held learning device comprising: (a) a housing; (b) a processor unit in the housing; (c) a memory unit coupled to the processor unit, wherein the memory unit comprises code for at least one problem; (d) a motion activated switch coupled to the processor unit, wherein the motion activated switch is activated after a user of the hand-held learning device moves the entire hand-held interactive learning device from a first position to a second position; and (e) an output device coupled to the processor unit for presenting the problem or an answer to the user.

Another embodiment of the invention is directed to a palm sized learning device comprising: (a) a housing; (b) a display screen, a plurality of direction switches, and a motion switch coupled to the housing; and (c) a processor unit inside of the housing, wherein the processor unit is preprogrammed to cause an image to appear on the display that presents the user with questions on basic arithmetic skills through the use of games and flash-card type drills; wherein the user enters an answer to a problem by flicking the device with a snapping motion of the wrist or by gently slapping the device against a palm or arm.

Another embodiment of the invention is directed to a method of using a learning device, the method comprising: (a) obtaining the learning device; (b) causing the learning device to present a problem; and (c) moving the entire learning device to activate a motion switch inside of the learning device to cause the learning device to present an answer to the problem or to enter a selection into the learning device.

These and other embodiments of the invention are described in further detail below.

### BRIEF DESCRIPTION OF THE DRAWINGS

FIG. 1 shows a front view of a learning device according to an embodiment of the invention.

FIG. 2 shows a learning device embodiment when it moves from a first position to a second position.

FIG. 3 shows a block diagram of some components of the learning device.

FIG. 4 shows an exemplary circuit diagram according to an embodiment of the invention.

FIG. 5 shows an exemplary flowchart of a method performed by the learning device in a learning mode.

FIG. 6 shows an exemplary flowchart of a method performed by the learning device in a quiz mode.

### DETAILED DESCRIPTION

A hand-held learning device is disclosed. The hand-held learning device includes a housing and a processor unit in the housing. A memory unit is coupled to the processor unit, and the memory unit comprises code for at least one problem. A motion activated switch is coupled to the processor unit. The motion activated switch is activated after a user of the hand-held learning device moves the entire hand-held interactive learning device from a first position to a second position. An output device is coupled to the processor unit and presents the problem or the answer to the problem to the user.

The learning device can be used to teach about a variety of subjects including spelling, history, fin facts, math, phonics, letters, words, pronunciation, etc. Accordingly, the memory unit in the learning device preferably comprises code for problems and answers such as math problems and answers. As will be explained in detail below, the learning device can present math problems in a drill fashion like flash cards so that a user can learn his or her addition, subtraction, multiplication, and division tables. In preferred embodiments, the learning device teaches the user addition, subtraction, multiplication, and division tables from 0 to 12.

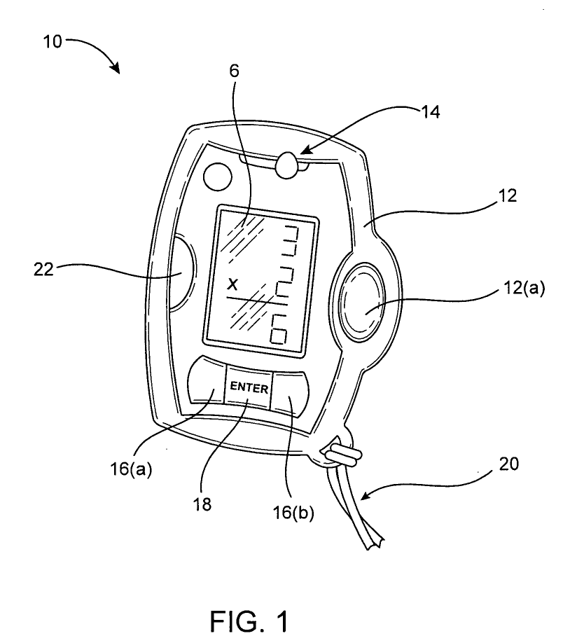

FIG. 1 shows a hand-held learning device 10 according to an embodiment of the invention. The learning device 10 includes a housing 12 including a depression 12(a) for receiving a thumb of a right-handed user. This depression 12(a) helps the user grasp the learning device 10 and helps the user easily move it to activate the motion activated switch inside of the housing 12.

Various output devices may be provided in the learning device 10. A display 6 such as a liquid crystal display (LCD) can be provided at the front of the learning device 10 and a speaker (not shown) can be provided at the back of the learning device. Providing a display 6 at the front and a speaker at the back of the learning device 10 reduces the overall size and lateral dimensions of the learning device 10. This is useful, since one way of inputting a selection into the learning device 10 is to move the entire learning device 10 from a first position to a second position. Making the learning device 10 small makes it easier for the user to grasp and move the learning device 10.

The learning device 10 may include a mode switch 14, which allows a user to switch between various operational modes. If the learning device 10 teaches addition and subtraction, it may include an addition learn mode, a subtraction learn mode, an addition quiz mode, and a subtraction quiz mode. If the learning device 10 teaches multiplication and division, the learning device 10 may include a multiplication learn mode, a division learn mode, a multiplication quiz mode, and a division quiz mode. Details of these modes are provided below.

The learning device 10 can include a number of pressure switches. As shown in FIG. 1, the learning device 10 includes a number button 22, directional buttons 16(a), 16(b), and an enter button 18. Each of these pressure switches is described in further detail below. Other switches or buttons could also be used in the learning device 10.

The number button 22 allows a user to change the number that the user is currently working with, by resetting the learning device 10 to its initial state. For example, in learn mode, the user may use the learning device 10 to learn about all numbers that can be added to the number “3” (e.g., 3+0, 3+1, 3+2, etc.). To change the number currently being drilled, the user may select the number button 22 to deselect the number “3” as the number being drilled. The user may then select a new number for drilling. For example, the user may press the number button 22 and then press the direction button 16(b) to select a new number such as the number “7” to drill addition problems using the number “7”.

The directional buttons 16(a), 16(b) include a first button 16(a) that displays numbers lower than a previously displayed number when pressed, and a second button 16(b) that displays numbers higher than the previously displayed number when pressed. For example, if the learning device 10 is in a learn mode, the number “1” may be initially displayed. If the user presses the first button 16(b), lower numbers such as “0” are displayed on the display 6. If the user presses the second button 16(b), higher numbers such as “2” and “3” are displayed on the display 6.

The enter button 18 is between the first and second direction buttons 16(a), 16(b). The enter button 18 allows a user to enter a particular selection. For example, the user may use the enter button 18 to select a specific number for a practice drill after scrolling through various potential candidate numbers using the direction buttons 16(a), 16(b). The enter button 18 can also cause the learning device 10 to display the answer to a problem. For example, the learning device 10 may display a math problem such as “1×2” and the user may cause the learning device 10 to display the answer “2” by pressing the enter button 18.

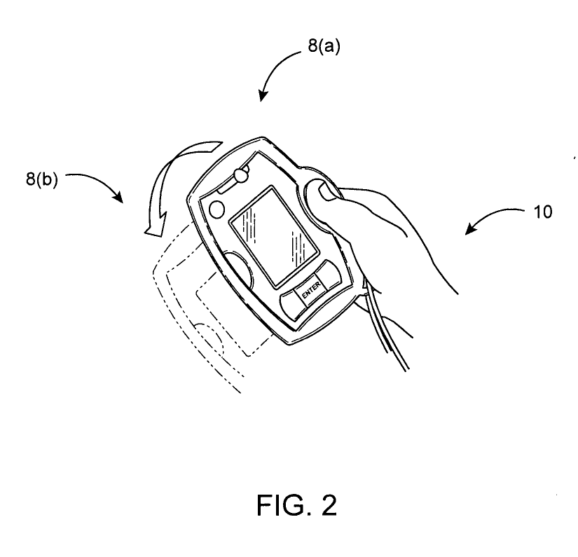

The learning device 10 can also include a motion activated switch. A number of specific types of motion activated switches are commercially available. The motion activated switch actives when the user moves the learning device 10 from a first position to a second position. The learning device 10 need not remain at the second position for any particular period of time. For example, the user can grasp the learning device 10 with one hand and can “flick-it” with a wrist flick to provide data input to the learning device 10. This is illustrated in FIG. 2.

FIG. 2 shows a user's hand that grasps the right side of a learning device 10. To see an answer to a math problem displayed on the screen 6, the user can move the learning device 10 from a first position 8(a) to a second position 8(b) with the flick of a wrist. In preferred embodiments, motion alone will not activate the motion switch. Rather, in preferred embodiments, rapid motion, where the learning device 10 is accelerated past a predetermined threshold, activates the motion activated switch. This encourages the child to interact with the learning device 10 by “flicking it” to receive an answer and/or to input a particular selection.

Providing the learning device 10 with a motion activated switch has a number of advantages. As noted above, one way that the user can cause the learning device to display an answer to a problem or to enter a selection into the learning device is by “flicking” the learning device. This way of inputting data into the learning device is more fun than simply pressing buttons and is consequently more engaging for the user. This makes learning with the learning device both fun and interactive and makes learning a difficult subject such as math also fun and engaging.

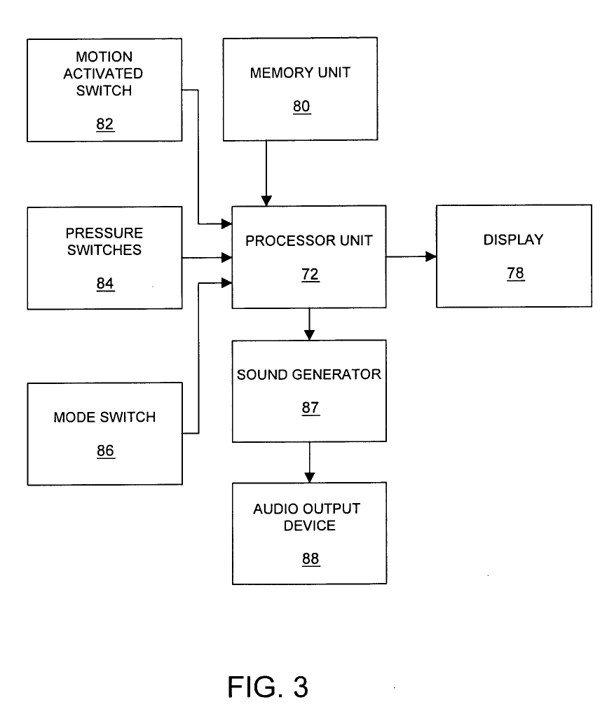

FIG. 3 shows a block diagram of some electronic components that can be used in the learning device. The learning device may comprise a processor unit 72 coupled to a memory unit 80, an audio output device 88 (e.g., an earphone jack, a speaker, etc.), and a display 78 (e.g., an LCD display, an LED display, etc.). A sound generator 87 for providing sound signals such as music, speech, and other audio signals may also be coupled to the processor unit 72. As is known by those of ordinary skill in the art, the processor unit 72, the memory unit 80, the sound generator 87, and other components such as a display driver can be embodied by one or more electrical components. For example, in some embodiments, an SPL31A chip commercially available from SunPlus Technologies Co., Ltd. could be used as a single chip in the learning device. This chip includes a CPU, SRAM, ROM, LCD controller, and other electronic components.

The memory unit 80 may comprise one or more ROM chips (read only memory), RAM chips (random access memory), EEPROM chips (electronically erasable programmable read only memory), etc. The memory unit 80 may comprise code for audio outputs and the operating system for the device. Computer code for performing any of the functions and any of the described operational modes described in this application can be created by those of ordinary skill in the art using any suitable programming language, and can be stored in a memory unit 80. Various scripts and process flows for these modes and other modes can be found in U.S. Provisional Patent Application No. 60/436,670, filed on Dec. 27, 2002, which is herein incorporated by reference in its entirety.

Data input components such as a motion activated switch 82, pressure switches 84, and a mode switch 86 can be operatively coupled to the processor unit 72. In preferred embodiments, the motion activated switch 82 comprises two conductors (e.g., two strips of wire), where a first conductor can flex to a greater extent than a second conductor. In the absence of motion, the first and second conductors are not in electrical communication with each other. When the learning device moves, the first conductor flexes and contacts the second conductor informing the processor unit 72 that the apparatus has just been moved and that the user has input information into the apparatus. To help facilitate this action, the end of the first conductor may include a weight (e.g., a bump of solder) to help the first conductor move and contact the second conductor when the learning device moves (or is “flicked”). Other details of these data input components have been described above and are described in further detail below.

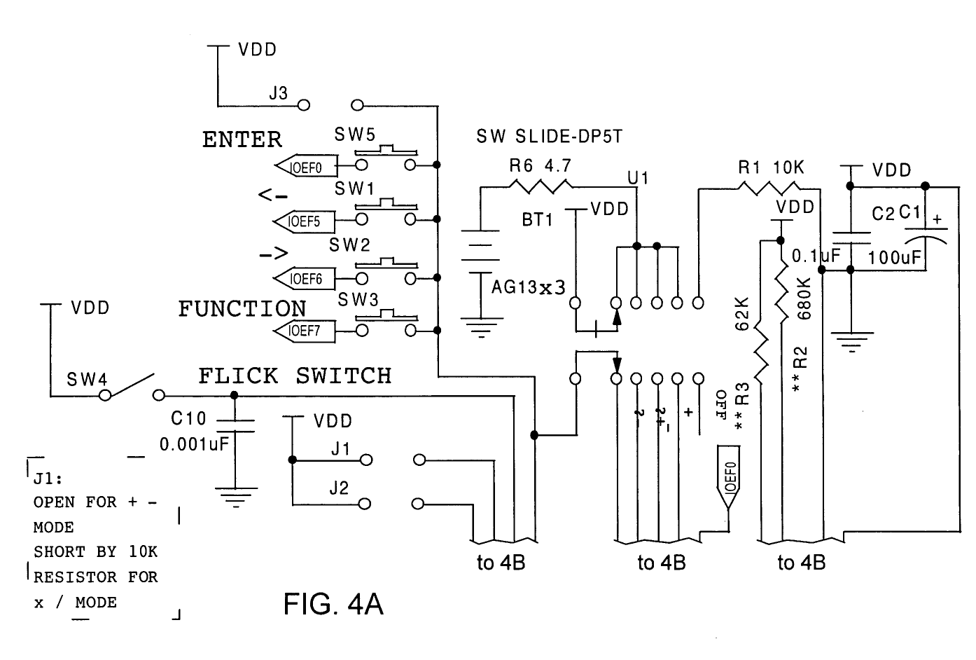

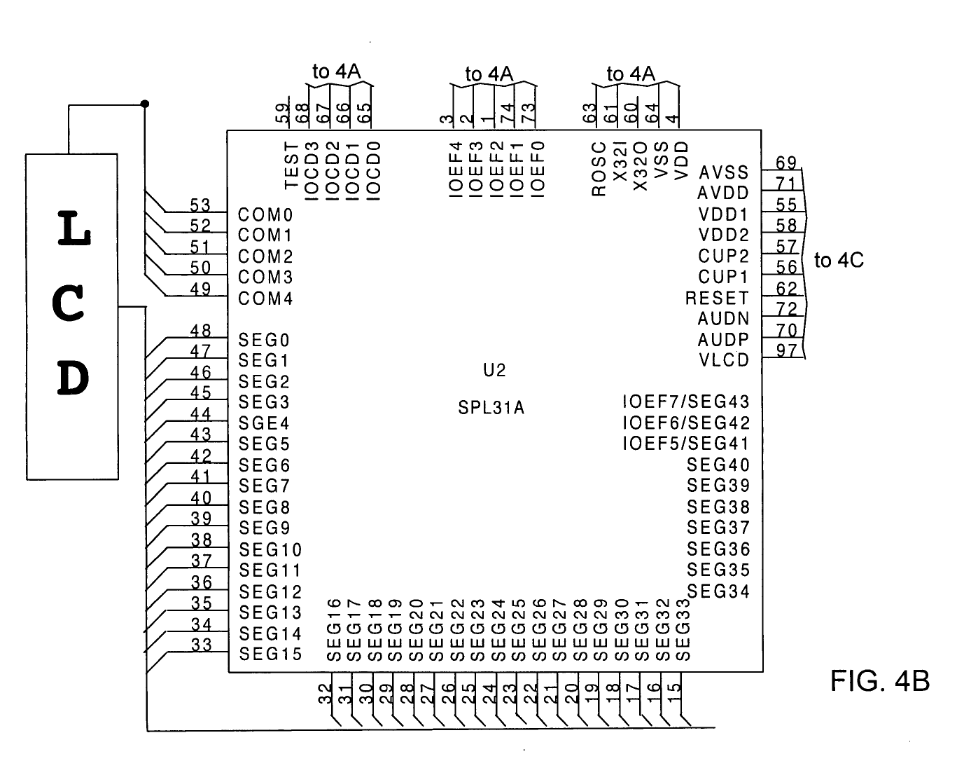

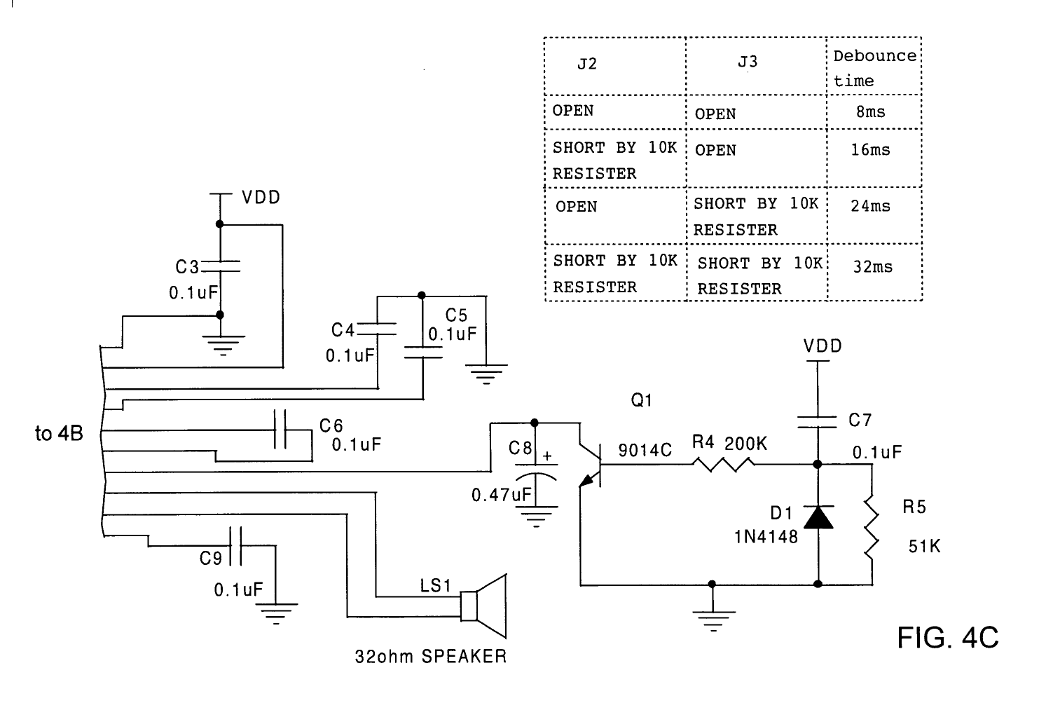

FIG. 4 shows an exemplary circuit diagram that can be used in an embodiment of the invention. It is understood that other circuit diagrams could be used in other embodiments of the invention.

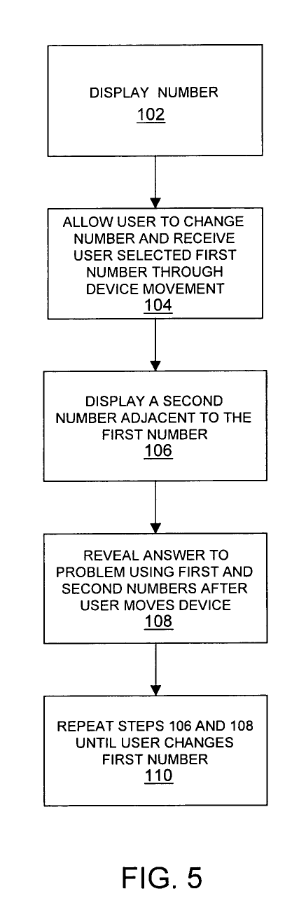

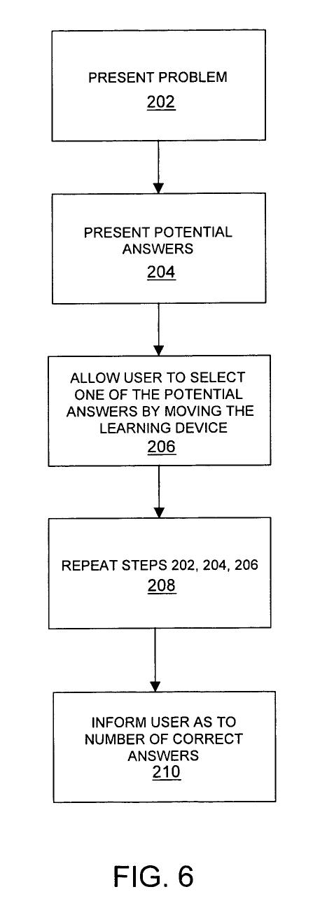

Exemplary methods of use can be described with reference to FIGS. 5 and 6.

FIG. 5 shows a flowchart of a method of using a learning device embodiment in a learn mode. Reference is also made to FIG. 1. First, after turning the learning device 10 on and using the mode selector switch 14 to select the learn mode for learning addition, the learning device 10 may display a number such as the number “0” (step 102). The user may then use the second direction button 16(b) to increase numbers until the number “2” is displayed. To select the number “2”, the user may either use the enter button 18 or the user may “flick” the learning device 10 to enter the number “2” (step 104). Then, the learning device 10 may drill the user adding different numbers with the number “2”. For example, the learning device 10 may thereafter display “0” under the number “2” on the display 6 (step 106). The user can then try and mentally answer the problem. To receive the answer to the problem, the user can either press the enter button 18 or the user can “flick” the learning device 10 (step 108). This process is repeated for different math problems using the number “2” (e.g., 2+1, 2+2, 2+3, etc.), until the user changes number being drilled and/or all numbers in a practice set are completed (step 110). In this way, the learning device 10 drills the user on adding with the number 2 in a way that is similar to flashcards. If the user wants to practice a drill using a different number, the user can press the number button 22 to reset to an initial state and then press direction button 16(a) or 16(b) to select the number. For example, the user can press the number button 22, and then can select the number “3” to drill in the same manner as described above. This same general methodology can be used to teach subtraction, multiplication, and division.

FIG. 6 shows a flowchart of a method of using the learning device in a quiz mode. Reference is also made to FIG. 1. First, after turning the learning device 10 on, the user may use the mode selector switch 14 to select the quiz mode for addition. Then, the number “0” is displayed on the display 6. The user can then use the second direction button 16(b) to increase the number displayed to the number “3” to have the learning device 10 quiz the user on adding using the number “3”. The user may press the enter button 18 or “flick” the learning device 10 to select “3”. The learning device 10 may then display “60 sec” (or other predetermined time period) on the display 6 to inform the user that a 60 second quiz will be given. Then, the learning device 10 displays random problems using the number “3” (step 202). For example, the equation “3+8” is displayed and potential answers such as “14”, “16”, and “11” are automatically displayed successively below a line that is below the problem “3+8” (step 204). When the user sees the correct answer “11”, the user can either depress the enter button 18 or “flick” the learning device 10 to indicate that the number “11” was selected (step 206). After the user answers (whether correctly or incorrectly) the displayed problem, the learning device 10 displays another problem using the number “3” (e.g., “3+2”) and the above process is repeated (step 208). After the 60 seconds is up, the quiz is over and the number of correct answers (and optionally the number of incorrect answers) is displayed to the user on the display 6 (step 210). In this way, a user can test her/himself on how well s/he knows the particular matter being tested.

It is understood that embodiments of the invention are not limited to the described embodiments and other embodiments are also possible. For example, a slot or data port may be provided in the learning device so that the learning device can be provided with new and different problems. If the learning device comprises a slot for a transferable memory device such as a data cartridge or a memory stick, new and different problems may be obtained via the Internet or via other means (e.g., downloading from a personal computer, or at a store). Also, the learning device may be programmed to adjust to the level of skill of the particular user by selecting problems for the user that are within the user's current intelligence zone. Problems above, below, and at the user's current zone may also be selected for the user to drill or quiz.

The learning device may also have other features. For example, the learning device may include an option for playing or not playing music during use in the various operational modes. The learning device may also have an automatic shut off feature if the user does not use the learning device within a predetermined time period. This increases the life of batteries that are use in the learning device. Code for performing these and other functions may be present in the memory unit that is described above.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. For example, although math is described in detail herein, embodiments of the invention could also teach a person about letters, phonics, spelling, and languages.

Moreover, any one or more features of any embodiment of the invention may be combined with any one or more other features of any other embodiment of the invention, without departing from the scope of the invention.

All patent applications, patents, and publications mentioned above are herein incorporated by reference in their entirety for all purposes. None is admitted to be prior art.

What is claimed is:

1. A hand-held learning device comprising:
(a) a housing;
(b) a processor unit in the housing;
(c) a memory unit coupled to the processor unit, wherein the memory unit comprises code for at least one problem;
(d) a motion activated switch coupled to the processor unit, wherein the motion activated switch is activated after a user of the hand-held learning device moves the entire hand-held interactive learning device from a first position to a second position; and
(e) an output device coupled to the processor unit for presenting the problem or an answer to the user.

2. The hand-held learning device of claim 1 wherein the at least one problem is a math problem

3. The hand-held learning device of claim 1 wherein the output device is a display and wherein the learning device further comprises:
an audio output device coupled to the processor unit.

4. The hand-held learning device of claim 3 further comprising at least one direction switch coupled to the processor unit and at least one mode selector switch coupled to the processor unit.

5. The hand-held learning device of claim 3 wherein the memory unit comprises code for (i) addition and subtraction learn modes and quiz modes, or (ii) multiplication and division learn modes and quiz modes.

6. The hand-held learning device of claim 3 wherein the housing comprises a depression for receiving a thumb of the user.

7. The hand-held learning device of claim 3 wherein the housing has lateral dimensions approximately equal to the size of the user's palm.

8. The hand-held learning device of claim 3 wherein the motion switch is activated by a flick of a wrist of the user.

9. The hand-held learning device of claim 1 further comprising at least one direction switch coupled to the processor unit and at least one mode selector switch coupled to the processor unit.

10. The hand-held learning device of claim 1 wherein the memory unit comprises code for (1) addition and subtraction learn modes and quiz modes, or (ii) multiplication and division learn modes and quiz modes.

11. The hand-held learning device of claim 1 wherein the housing comprises a depression for receiving a thumb of the user.

12. The hand-held learning device of claim 1 wherein the housing has lateral dimensions approximately equal to the size of the user's palm.

13. The hand-held learning device of claim 1 wherein the motion switch is activated by a flick of a wrist of the user.

14. The hand-held learning device of claim 1 wherein the memory unit comprises code for at least one problem and code for (i) addition and subtraction learn modes and quiz modes, or (ii) multiplication and division learn modes and quiz modes, and wherein the learning device further comprises a number button for changing a number that is drilled by the learning device.

15. A palm sized learning device comprising:
(a) a housing;
(b) a display screen, a plurality of direction switches, and a motion switch coupled to the housing; and
(c) a processor unit inside of the housing, wherein the processor unit is preprogrammed to cause an image to appear on the display that presents the user with questions on basic arithmetic skills through the user of games and flash-card type drills;
wherein the user enters an answer to a problem by flicking the device with a snapping motion of the wrist or by gently slapping the device against a palm or arm.

16. The device of claim 15 further comprising a sound generator coupled to the processor unit and a speaker coupled to the sound generator, wherein the processor unit causes an audio signal to be generated that corresponds to an image on the display screen.

17. A method of using a learning device, the method comprising:
(a) obtaining the learning device;
(b) causing the learning device to present a problem; and
(c) moving the entire learning device to activate a motion switch inside of the learning device to cause the learning device to present the answer to the problem or to enter a selection into the learning device.

18. The method of claim 17 wherein the problem is a math problem.

19. The method of claim 18 wherein (c) moving the entire learning device comprises accelerating the learning device past a predetermined acceleration threshold, wherein the motion switch is activated after the acceleration of the learning device is greater than the predetermined acceleration threshold.

20. The method of claim 18 wherein the learning device comprises a housing with a depression for a user's thumb.

21. The method of claim 18 wherein the learning device is adapted to teach about letters or phonics.

22. The method of claim 18 wherein the learning device is adapted to teach about language.
